(19) United States
(12) Patent Application Publication
(10) Pub. No.: US 2009/0188631 A1
(43) Pub. Date: Jul. 30, 2009

(54) Tape supplier and refill cartridge for binding apparatus

(76) Inventor: Seung-Kyoon Noh, Seoul (KR)

Correspondence Address: BIRCH STEWART KOLASCH & BIRCH, PO BOX 747, FALLS CHURCH, VA, 22040-0747, US

(21) Appl. No.: 10/585,411

(22) PCT Filed: Dec. 6, 2004
(86) PCT No.: PCT/KR2004/003186

§ 371 Date: Jul. 7, 2006

(30) Foreign Application Priority Data
Jan. 7, 2004 (KR) 10-2004-0000855

(51) Int. Cl. B42C 1/00

(52) U.S. Cl. 156/459

(57) ABSTRACT

A tape supplier and a refill cartridge for a binding apparatus are disclosed, which can prevent a supply error of a tape from occurring and facilitate supply of the tape. Also, an outer surface of the tape is not contaminated by an additive when the tape is supplied. A tape cassette 156 constituting the tape supplier includes a first rotational shaft 91 rotatably supporting a tape roll 140, a second rotational shaft 92 designed to collect a sheet 127a of the tape roll by winding the same in a roll type, a third rotational shaft 93 designed to collect a sheet 127b by winding the same in a roll type, and a tape ejection roller assembly 95 outwardly ejecting a tape provided between the two sheets. A refill cartridge 120 is designed such that the tape roll 140 having tapes 132a, 132b, . . . inserted between the sheets is fixed to a first fork pipe 121 having a through hole at the center, outer ends of the sheets are respectively fixed to a second fork pipe 122 and a third fork pipe 123 each having a through hole at the center, and the first to third fork pipes are supported inside an external box 130. Particularly, the refill cartridge 120 is built in the tape cassette 156 so that the first, second and third fork pipes are respectively fixed to the first, second and third rotational shafts 91, 92 and 93 through the through holes.

### TECHNICAL FIELD

The present invention relates to a binding device that binds papers ejected from a digital output device such as a printer and a copier after finishing them, and more particularly to a tape supplier for a binding apparatus and a refill cartridge that supplies a tape to the tape supplier.

### BACKGROUND ART

An example of a conventional binding device for a digital output device such as a copier will be described with reference to the Korean Patent Application No. 2003-22319 filed by this applicant on Apr. 4, 2003.

The conventional binding device 1 includes a paper processing unit 5, a paper carriage 2, a tape supplier 6, a tape heating unit 7, and a receiving stacker 8. The paper processing unit 5 is provided with a paper aligning unit 3 and a binding unit 4. The paper carriage 2 includes an inlet 9a and an outlet 9b. A plurality of rollers 10 are provided between the inlet 9a and the outlet 9b. A flapper 13 is provided at the inlet 9a so that papers are flapped to a paper carriage path 14 when binding papers. The papers flapped to the paper carriage path 14 by the flapper 13 are moved to the paper aligning unit 3. The paper aligning unit 3 includes a tray 16 receiving papers, an aligning paddle 18 aligning moved papers, a stop finger 19 putting the papers in a standby state, and a paper clamp 15 gripping the papers aligned in the stop finger 19 and moving them to the tape heating unit 7.

The stop finger 19 and the paper clamp 15 are designed to grip the papers stacked on the tray 16 to move them to the tape heating unit 7. Once the papers are moved to the tape heating unit 7, the papers are subjected to the binding process so that a tape fed from the tape supplier 6 is adhered to the sections and sides of the papers. The paper clamp 15 moves the bound papers to the binding carriage 4 and returns to the position where it first grips the papers. The bound papers are then stacked on the receiving stacker 8 by the binding carriage 4.

In the aforementioned binding device, the tape supplier 6 and the tape heating unit 7 will be described in more detail.

The tape heating unit 7 includes a tape guide 26, a center heater 27, and a driving gear 30 driving the center heater 27. The tape guide 26 is supplied with a tape 132a from the tape supplier 6 before the papers aligned by the paper aligning unit 3 are moved to the tape heating unit 7.

A solid state additive 111 is adhered to one side of the tape. The additive 111 is changed to a liquid state if it is heated at a predetermined temperature between 100° C. and 200° C. This side of the tape is adhered to the sections of the papers.

The conventional tape supplier 6 supplying the tape 132a includes a tape cassette 56 having tapes 132a, 132b, 132c, . . . cut at a predetermined size, first and second teeth rollers 51 and 52 moving the tape built in the tape cassette, and a tape supplying motor 50 simultaneously rotating the first and second teeth rollers 51 and 52.

A frictional pad 53 is provided at a portion corresponding to the second teeth roller 52. A tape ejection outlet 60 is provided between the frictional pad 53 and the second teeth roller. The tape is ejected to a tape feeding roller 55 through the tape ejection outlet 60. A pressurizing spring 54 is provided at the frictional pad 53 and acts its elastic force on the second teeth roller 52. An arc shaped frictional surface 61 is provided at the frictional pad 53 to allow the end of the tape 132b following the tape 132a to be easily removed and ejected.

The first and second teeth rollers 51 and 52 driven by the tape supplying motor 50 are respectively provided with a one-way bearing 62. The tape feeding roller 55 and a tape sensor 59 are provided outside the tape ejection outlet 60.

However, the aforementioned conventional tape supplier 6 has several problems.

The tapes 132a, 132b, 132c, . . . with the solid state additive 111 are ejected out in a state that they are sequentially applied in the tape cassette 56. In this case, since the additive is melted under high temperature conditions, the surfaces of the sequentially applied tapes are likely to be adhered to one another. For this reason, it is difficult to remove the tapes from one another. Thus, poor ejection of the tapes is frequently caused. In addition, since the tapes are contaminated by the melted additive, a spot occurs on the outer surface of the tape, thereby deteriorating the quality of the binding papers.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a structure of a conventional binding apparatus with a tape supplier;

FIG. 2 and FIG. 3 illustrate a structure of a conventional tape supplier;

FIG. 4 illustrates a general structure of a tape refilled in a conventional tape supplier;

FIG. 5 is an exploded perspective view illustrating a tape supplier according to the present invention;

FIG. 6 is an elevational view illustrating a tape supplier according to the present invention;

FIG. 7 is an exploded perspective view illustrating a tape ejection roller assembly constituting a tape supplier according to the present invention;

FIG. 8 is an elevational view illustrating a refill cartridge according to the present invention;

FIG. 9 is an exploded perspective view illustrating a refill cartridge according to the present invention;

FIG. 10 illustrates a structure of a tape wound in a refill cartridge according to the present invention in a roll type;

FIG. 11 illustrates the state that a refill cartridge is inserted into a tape cassette of a tape supplier according to the present invention;

FIG. 12 illustrates the state that a rotational shaft of a tape cassette is fixed to a fork pipe of a refill cartridge according to the present invention;

FIG. 13 illustrates the step of ejecting a tape from a refill cartridge inserted into a tape cassette of a tape supplier according to the present invention;

FIG. 14 and FIG. 15 illustrate the step of detaching a tape from a refill cartridge when the tape is ejected from the refill cartridge according to the present invention; and

FIG. 16 to FIG. 18 illustrate an example of a sensing portion provided in a tape roll according to the present invention.

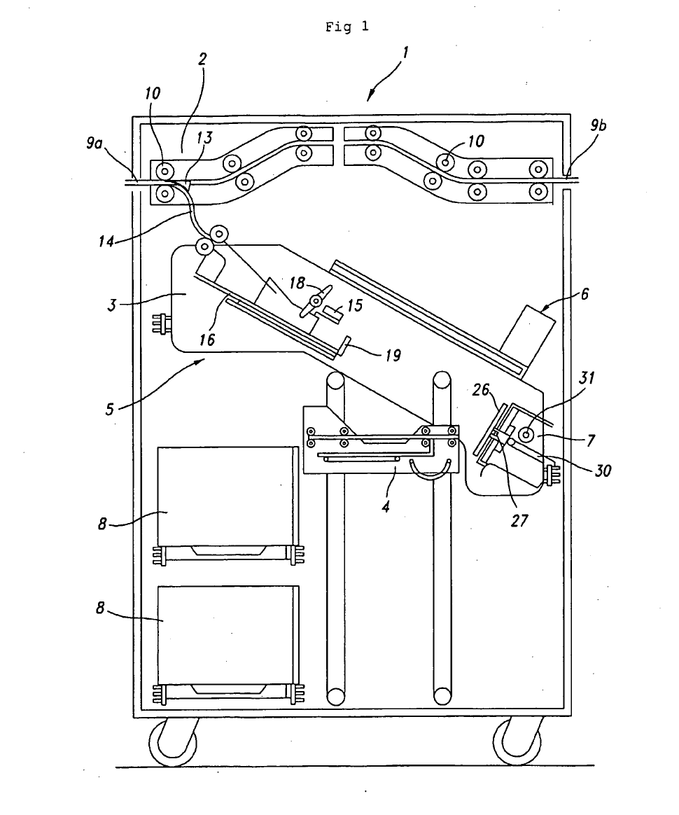

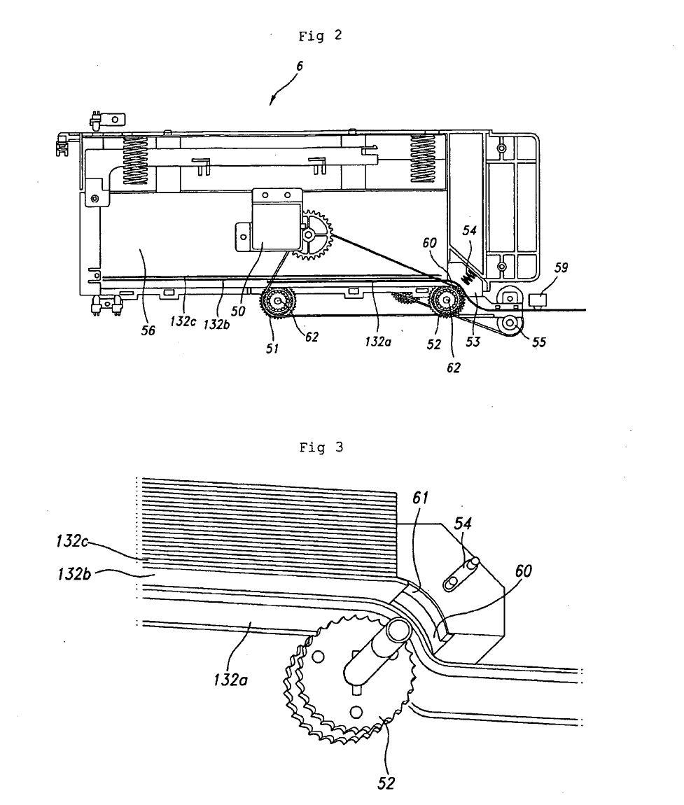

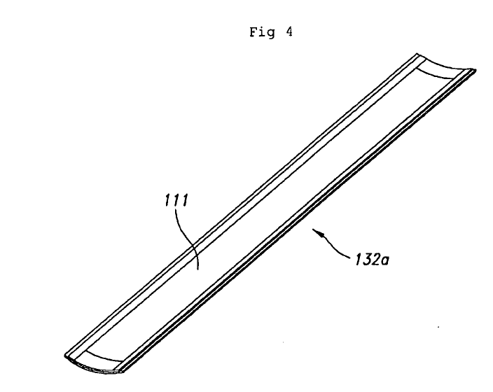

### DETAILED DESCRIPTION OF THE INVENTION

### Technical Problems

Accordingly, the present invention is directed to a tape supplier and a refill cartridge for a binding apparatus that substantially obviates one or more of the problems due to limitations and disadvantages of the related art.

An object of the present invention is to a tape supplier and a refill cartridge for a binding apparatus in which a tape inserted between two sheets is wound in a roll type using a refill cartridge to be easily built in a tape cassette, thereby removing a supply error of the tape.

Another object of the present invention is to provide a tape supplier and a refill cartridge for a binding apparatus that can prevent a supply error of a tape from occurring and facilitate supply of the tape.

Still another object of the present invention is to provide a tape supplier and a refill cartridge for a binding apparatus in which an outer surface of a tape is not contaminated by an additive so as to improve the quality of the binding papers.

Other object of the present invention is to provide a tape supplier and a refill cartridge for a binding apparatus in which a tape is simply set in a tape cassette and a sheet surrounding the tape is easily collected.

### TECHNICAL SOLUTIONS

To achieve these and other advantages and in accordance with the purpose of the present invention, as embodied and broadly described, a tape supplier includes a tape cassette 156 having a tape roll with tapes inserted between two sheets, and a tape cassette driver driving the tape cassette, wherein the tape cassette includes a first rotational shaft rotatably supporting the tape roll, a second rotational shaft designed to collect one of the two sheets by winding the same in a roll type, a third rotational shaft designed to collect the other of the two sheets by winding the same in a roll type, and a tape ejection roller assembly outwardly ejecting a tape from which the two sheets are removed, and the tape cassette driver is designed to drive the second and third rotational shafts.

The second and third rotational shafts have a rotational speed different from each other.

The tape roll is built in the refill cartridge to be easily provided in the tape cassette.

The refill cartridge includes a first fork pipe, a second fork pipe, and a third fork pipe provided with a through hole at the center in an external box, and an ejection outlet provided in the external box, ejecting tapes inserted between two sheets, wherein a tape roll with the tapes inserted between the sheets is fixed to the first fork pipe, the end of one of the sheets is fixed to the second fork pipe, and the end of the other is fixed to an outer surface of the third fork pipe.

The tapes are arranged at constant intervals in a straight line.

At least one of the sheets includes a sensing portion that senses ejection of the tapes.

The refill cartridge which is expendable is built in the tape cassette in such a manner that the through hole of the first fork pipe is inserted into the first rotational shaft, the through hole of the second fork pipe into the second rotational shaft, and the through hole of the third fork pipe into the third rotational shaft.

If the refill cartridge is built in the tape cassette, the tape cassette driver is driven to outwardly eject the tape built in the refill cartridge through the ejection outlet of the refill cartridge and the tape ejection roller assembly of the tape cassette. Also, the sheets are collected by being wound in the second and third fork pipes of the refill cartridge, and then the used refill cartridge is removed from the tape cassette.

### Applicable Advantages

A tape cassette 156 of the present invention includes a first rotational shaft 91 rotatably supporting a tape roll 140, a second rotational shaft 92 designed to collect a first sheet 127a by winding the same in a roll type, a third rotational shaft 93 designed to collect a second sheet 127b by winding the same in a roll type, and a tape ejection roller assembly 95 outwardly ejecting a tape from which the two sheets are removed.

A refill cartridge 120 is designed such that the tape roll 140 having tapes 132a, 132b, . . . inserted between the sheets 127a and 127b is fixed to a first fork pipe 121 having a through hole at the center, outer ends of the sheets 127a and 127b are respectively fixed to a second fork pipe 122 and a third fork pipe 123 each having a through hole at the center, and the first to third fork pipes are supported inside an external box 130.

Particularly, the refill cartridge 120 is built in the tape cassette 156 so that the first, second and third fork pipes are respectively fixed to the first, second and third rotational shafts 91, 92 and 93 through the through holes.

In the aforementioned tape cassette 156 and the refill cartridge 120 of the present invention, a supply error of a tape of a binding apparatus is avoided. Also, the tape is not contaminated by an additive when it is supplied to the tape cassette. Moreover, it is possible to simply set the refill cartridge having a thin box shape in the tape cassette and easily collect the sheets of the tape.

### BEST MODE FOR CARRYING OUT THE INVENTION

Reference will now be made in detail to the preferred embodiments of the present invention, examples of which are illustrated in the accompanying drawings.

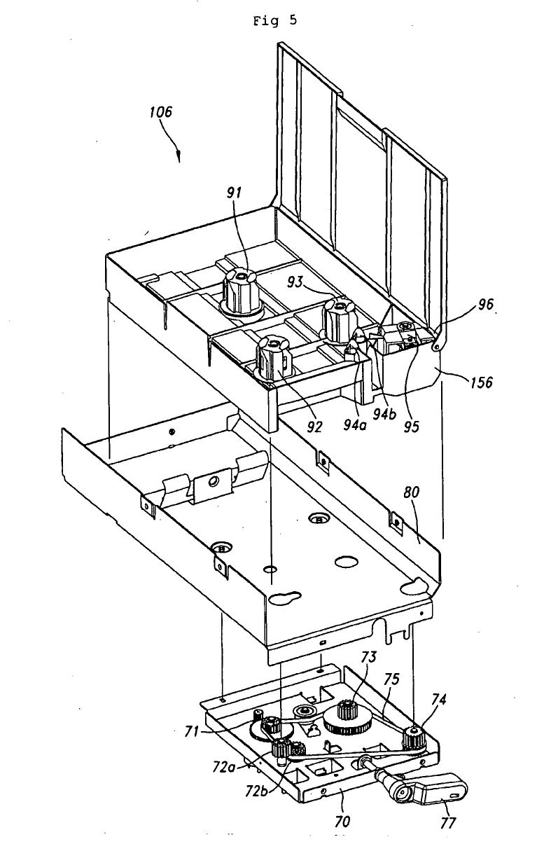

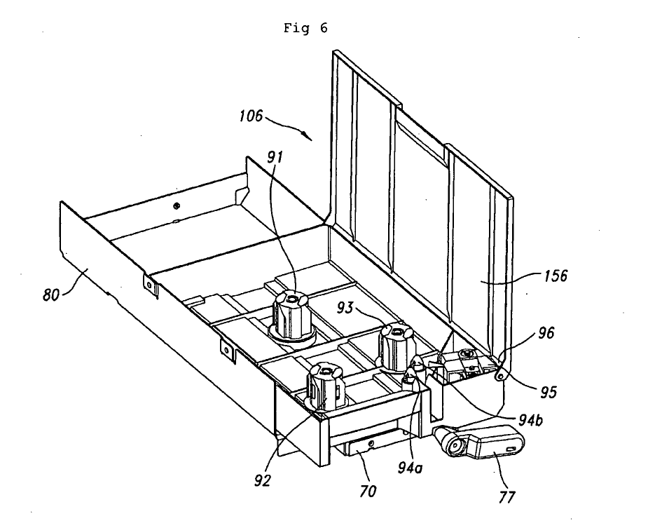

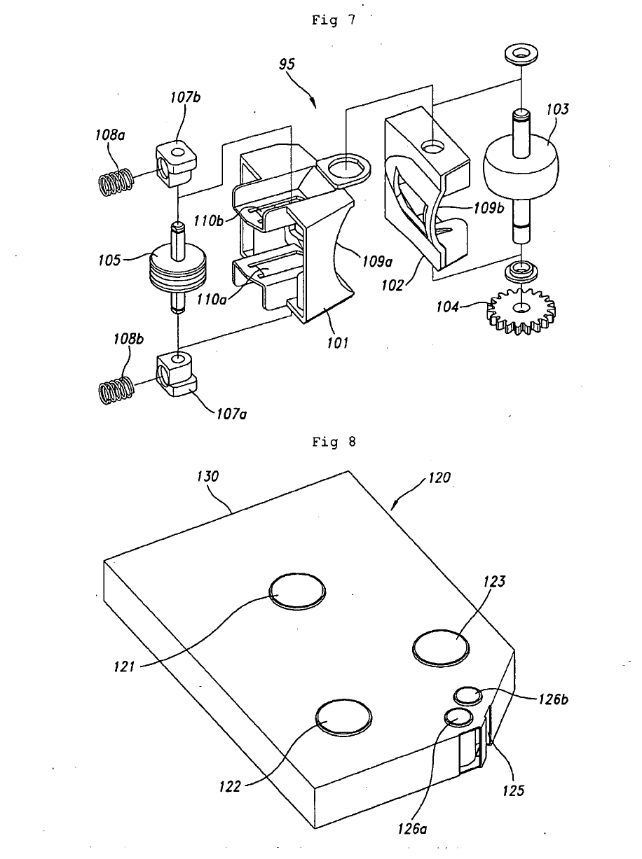

A tape cassette constituting a tape supplier and a refill cartridge built in the tape cassette according to the present invention will be described with reference to FIG. 5 to FIG. 18.

A tape supplier 106 of the present invention includes a tape cassette driver 70, a support frame 80, and a tape cassette 156.

The tape cassette driver 70 is fixed to the lower portion of the support frame 80, and the tape cassette 156 is fixed to the upper portion of the support frame 80.

The tape cassette 156 is designed to be detachably fixed to a binding apparatus by a lock handler 77 provided in the tape cassette driver 70. Since the structure by the lock handler 77 is well-known, its detailed description will be omitted.

The tape cassette driver 70 includes a first driving gear 71, second driving gears 72a and 72b, a third driving gear 73, and a fourth driving gear 74. The driving gears are connected with a timing belt 75 so that they are simultaneously rotated. Once the power is transmitted to the first driving gear 71 by a driving motor (not shown), the second driving gears 72a and 72b, the third driving gear 73 and the fourth driving gear 74 are simultaneously rotated along with the first driving gear 71.

Particularly the second driving gear 72a is rotated in a direction opposite to a rotational direction of the second driving gear 72b connected to the timing belt.

The tape cassette 156 detachably fixed to the support frame 80 includes a first rotational shaft 91, a second rotational shaft 92, a third rotational shaft 93, a pair of idle roller shafts 94a and 94b, an ejection roller assembly 95, and a tape ejection outlet 96.

The ejection roller assembly 95 includes a main body 101, a support 102 fixed to the main body 101, a tape feeding roller 103, and a roller 105 adjoining the feeding roller. The main body 101 includes an arc shaped clearance formed between tape ejection guides 109a and 109b. The arc shaped clearance serves as the tape ejection outlet 96.

The tape feeding roller 103 and a roller 105 adjoining the feeding roller 103 are provided at the arc shaped clearance, i.e., the tape ejection outlet. The tape feeding roller 103 is fixed to a tape feeding roller gear 104. Both shafts of the roller 105 adjoining the tape feeding roller 103 are inserted into bushes 107a and 107b so that the roller 105 is to be tightly fixed to the feeding roller 103 with elasticity.

The bushes 107a and 107b are elastically fixed to the main body 101 in a state that they are pressurized by pressurizing springs 108a and 108b. The bushes 107a and 107b are moved along slots 110a and lob formed in the main body.

As described above, a frictional force at a contact portion between the tape feeding roller 103 and the roller 105 can be enhanced by elastically fixing the roller 105 to the main body 101 by the pressurizing springs. Also, a tape passing through between the tape feeding roller 103 and the roller 105 can easily be ejected. The tape can exactly be fed and ejected even if there is a difference in thickness of the tape.

When the aforementioned tape cassette 156 is built in the support frame 80, the first rotational shaft 91 is formed of a clamp shaft to which a rotational force from the tape cassette driver 70 is not directly transmitted. The second rotational shaft 92 and the third rotational shaft 93 are rotated in a state that they are respectively fixed to the second driving gear 72a and the third driving gear 73 of the tape cassette driver 70.

The rotational speed of the second rotational shaft 92 is faster than that of the third rotational shaft 93. The tape feeding roller gear 104 of the tape ejection roller assembly is rotated in a state that it is fixed to the fourth driving gear 74 of the tape cassette driver 70.

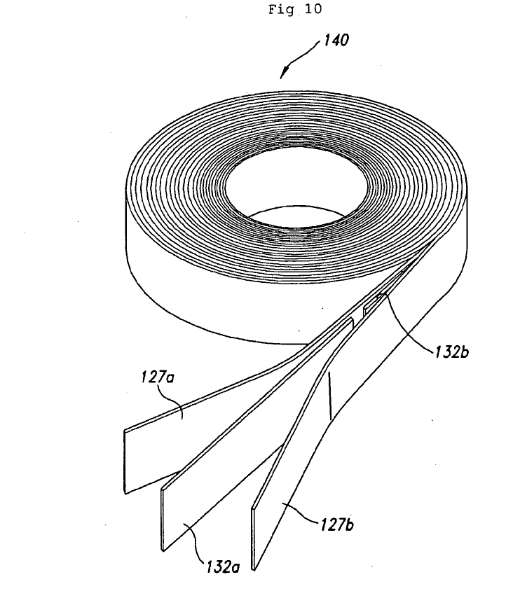

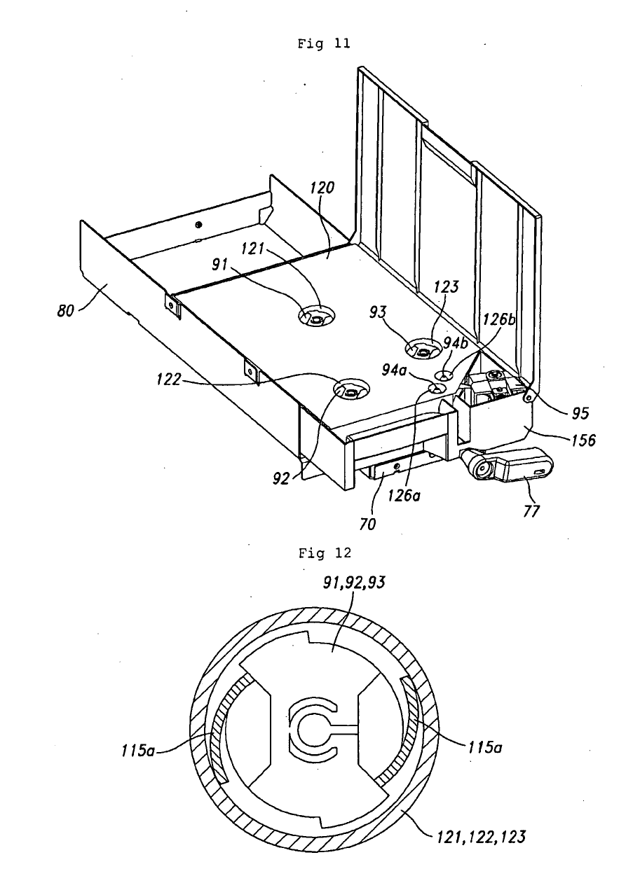

Meanwhile, as shown in FIG. 12, resilient arms 115a and 115b are provided on the outer surface of the first, second and third rotational shafts 91, 92 and 93 of the tape cassette 156. The operation of the resilient arms will be described later.

A refill cartridge 120 refilled in the tape cassette 156 will now be described in more detail.

A first fork pipe 121, a second fork pipe 122 and a third fork pipe 123 are provided in an external box 130 of a rectangular box shaped thin sheet.

The tape ejection outlet 125 is provided at the side of the external box between the second and third fork pipes 122 and 123. Fork pipes (sheet pipes) 126a and 126b for idle roller shafts are provided at the tape ejection outlet 125. Idle roller shafts 94a and 94b provided in the tape cassette 156 are respectively inserted into the fork pipes 126a and 126b.

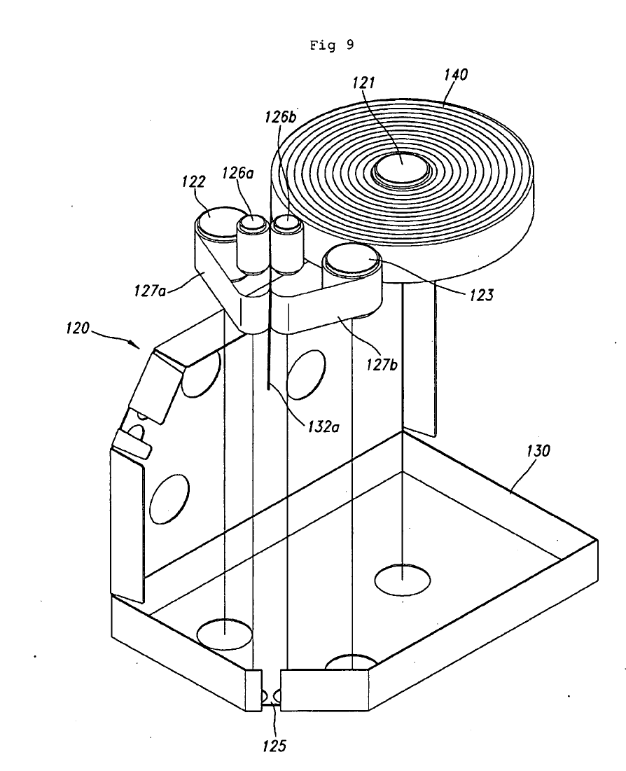

As shown in FIG. 9 and FIG. 10, a tape roll 140 having tapes 132a, 132b, . . . is fixed to the outer surface of the first fork pipe 121. The tapes 132a, 132b, . . . are arranged at constant intervals between the first and second sheets 127a and 127b. An outer end of the first sheet 127a is fixed to the outer surface of the second fork pipe 122, and an outer end of the second sheet 127b is fixed to the outer surface of the third fork pipe 123.

The first sheet 127a fixed to the second fork pipe 122, the second sheet 127b fixed to the third fork pipe 123, and the tapes 132a and 132b pass through between the fork pipes 126a and 126b. The sheets 127a and 127b are collected by being respectively wound in the second fork pipe 122 and the third fork pipe 123 as the tape roll 140 is unwound by rotation. The tapes 132a, 132b, . . . provided between the sheets are ejected through the tape ejection outlet 125.

The aforementioned refill cartridge 120, as shown in FIG. 11, is built in the tape cassette 156 in such a manner that the first fork pipe 121 is inserted into the first rotational shaft 91, the second fork pipe 122 is inserted into the second rotational shaft 123, and the third fork pipe 123 is inserted into the third rotational shaft 93. The tapes 132a, 132b, . . . wound in the refill cartridge by driving of the tape cassette driver 70 are outwardly ejected through the ejection roller assembly 95 and the ejection outlet 125.

The refill cartridge which has used up all the tapes is removed from the tape cassette and is replaced with a new refill cartridge. Particularly, the first rotational shaft, the second rotational shaft and the third rotational shaft are tightly inserted into the respective fork pipes 121, 122 and 123 by the resilient arms 115a and 115b formed in the first rotational shaft, the second rotational shaft and the third rotational shaft.

The resilient arms 115a and 115b formed in the first rotational shaft 91 support the first fork pipe 121 to generate sliding (torque limiter) in the first fork pipe when the first rotational shaft is inserted into the first fork pipe 121.

The resilient arms 115a and 115b formed in the second rotational shaft 92 serves to generate sliding (torque limiter) in the second fork pipe 122 because the second rotational shaft 93 rotates faster than the third rotational shaft. The generated sliding properly maintains tension in the first sheet 127a wound in the second fork pipe 122.

The resilient arms 115a and 115b formed in the third rotational shaft 93 support the third fork pipe 123 to easily unwind the tape roll 140.

As described above, the resilient arms formed in the third rotational shaft 93 support the inner surface of the fork pipe so as not to generate sliding. The resilient arms formed in the first rotational shaft 91 and the second rotational shaft 92 generate sliding (torque limiter) in the second fork pipe when a predetermined load is given thereto. This structure can avoid some errors in unwinding the tapes and collecting the sheets.

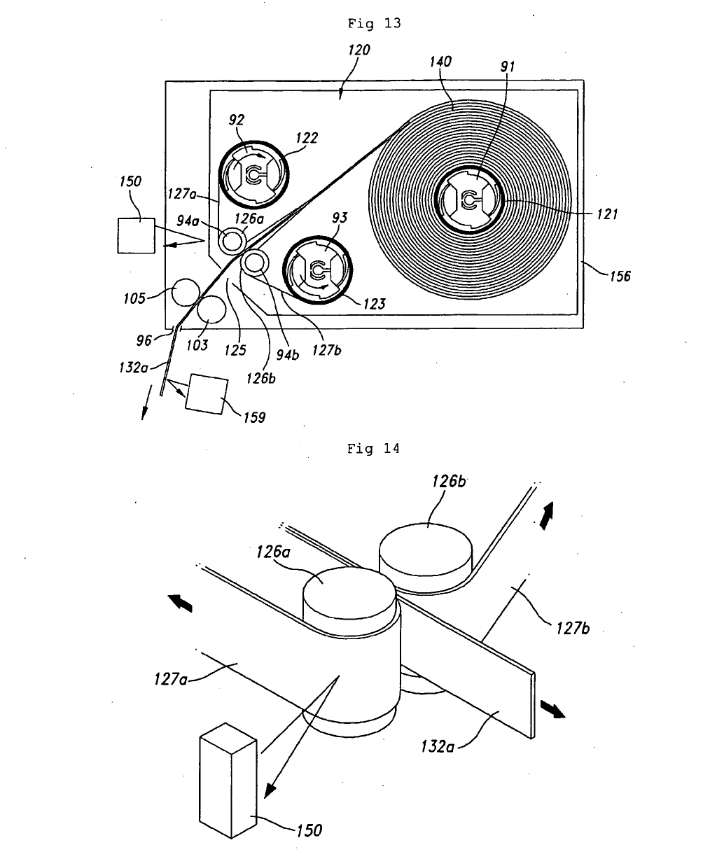

Hereinafter, the step of ejecting a tape according to the present invention will be described in more detail with reference to FIG. 13 to FIG. 15.

The refill cartridge 120 is built in the tape cassette 156 in such a manner that its first fork pipe 121 is inserted into the first rotational shaft 91 of the tape cassette 156, the second fork pipe 122 to the second rotational shaft 92, the third fork pipe 123 to the third rotational shaft 93, and the idle roller shafts 94a and 94b to the fork pipes 126a and 126b for the idle roller shafts.

If the tape cassette is driven in a state that the refill cartridge is built in the tape cassette, the tape roll 140 wound in the first fork pipe 121 is unwound depending on rotation of the third fork pipe 123.

The first sheet 127a of the tape roll 140 is collected by being wound in the outer surface of the second fork pipe 122 while the second sheet 127b is collected by being wound in the outer surface of the third fork pipe 123.

The tapes 132a, 132b, . . . between the sheets are ejected to the ejection outlet 96 through the ejection outlet 125, the feeding roller 103, and the roller 105.

A plurality of sensors 150 and 159 are provided in the tape cassette to control the ejection speed and the ejection position of the tapes 132a, 132b, . . . . For example, the sensor 159 senses the ejection position of the tapes to control the movement position of the tapes. The sensor 150 senses the rotation of the tapes to control the operation of the tape cassette driver 70.

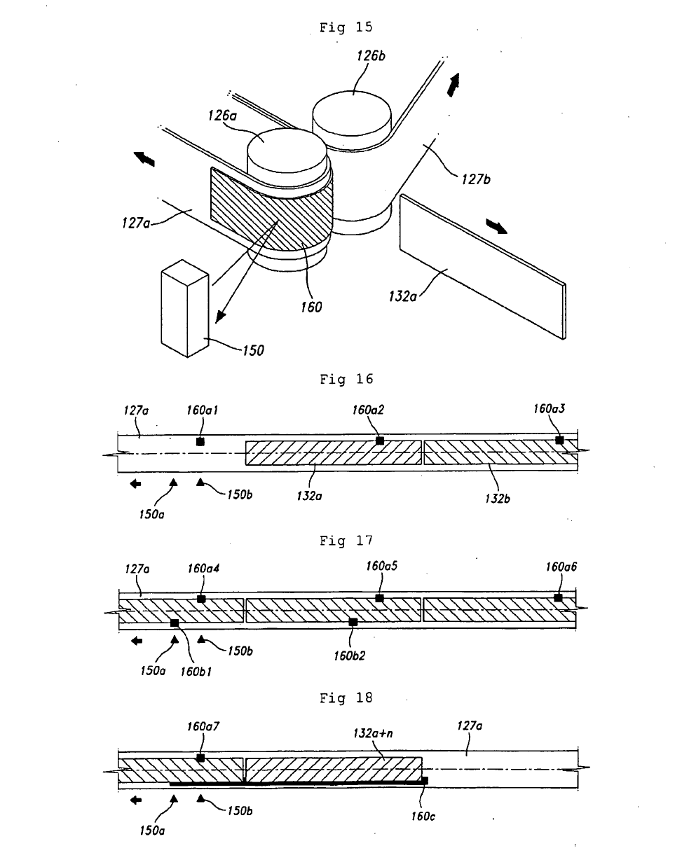

The sensor 150, as shown in FIG. 14, serves to rotate the tape roll 140 by driving the tape cassette driver 70 when there is no sensing portion at the first sheet 127a. Also, as shown in FIG. 15, the sensor 150 senses the ejection of the tape 132a when there is a sensing portion 160 formed at the first sheet 127a, and sends a signal to temporarily stop driving of the tape cassette driver 70 until a signal of the next binding operation is generated.

An example of the sensing portion 160 formed at the first sheet 127a will be described with reference to FIG. 16 to FIG. 18.

FIG. 16 illustrates a sensing portion provided at a start point for unwinding of a tape, FIG. 17 illustrates a sensing portion provided at an end point for unwinding of a tape, and FIG. 18 illustrates a sensing portion provided at the position of the last tape.

As shown in FIG. 16, in the first sheet 127a, sensing portions 160a1, 160a2, 160a3, . . . are provided at constant intervals at the front of the tapes 132a, 132b, . . . arranged at constant intervals from the start point for unwinding of the tape. Movement of the tape is temporarily stopped when the respective sensing portions 160a1, 160a2, 160a3, . . . are sensed by one of two sensors 150a and 150b constituting the sensor 150.

Sensing portions 160b1 and 160b2 are provided to sense the position of the last tape as shown in FIG. 17. The sensing portions 160b1 and 160b2 are sensed by the sensor 150b. If the sensor 150b senses the sensing portion 160b and at the same time the sensor 150a senses the sensing portion 160a4, it is determined that it approaches to unwinding for the last tape.

As shown in FIG. 18, a consecutive stripe shaped sensor 160c is provided at the front of the last tape. If the sensor 150a senses the sensing portion 160c after the sensor 150b senses the sensing portion 160a7, it is determined that there is the last tape 132a+n.

As described above, since the sensing portions are provided in the sheet of the tape to sense the start point for unwinding of the tape and the end point for unwinding of the tape, it is possible to recognize the used-up state of the tape.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A tape supplier comprising:
a tape cassette 156 having a tape roll 140 with tapes 132a, 132b, . . . inserted between two sheets 127a and 127b; and
a tape cassette driver 70 driving the tape cassette 156,
wherein the tape cassette 156 includes a first rotational shaft 91 rotatably supporting the tape roll 140, a second rotational shaft 92 designed to collect one of the two sheets 127a and 127b by winding the same in a roll type, a third rotational shaft 93 designed to collect the other of the two sheets by winding the same in a roll type, and a tape ejection roller assembly 95 outwardly ejecting a tape from which the two sheets are removed, and the tape cassette driver is designed to drive the second and third rotational shafts.

2. The tape supplier according to claim 1, further comprising idle roller shafts 94a and 94b provided in the vicinity of the ejection roller assembly 95 to simultaneously pass through the sheets 127a and 127b and the tapes 132a, 132b, . . . .

3. The tape supplier according to claim 1, wherein the second and third rotational shafts are simultaneously driven by a timing belt 71.

4. The tape supplier according to claim 1, wherein the second and third rotational shafts have a rotational speed different from each other.

5. The tape supplier according to claim 1, wherein the first rotational shaft serves as a clamp shaft.

6. The tape supplier according to claim 1, wherein one of the second and third rotational shafts, which has a rotational speed faster than the other, includes torque limiter means.

7. The tape supplier according to claim 6, wherein the torque limiter means are of resilient arms 115a and 115b.

8. The tape supplier according to claim 1, wherein the ejection roller assembly 95 includes a tape feeding roller 103, and the tapes 132a, 132b, . . . are outwardly ejected by the feeding roller.

9. The tape supplier according to any one of claims 1 to 8, wherein the tape roll 140 is fixed to a first fork pipe 121 having a through hole at the center, ends of the sheets 127a and 127b are respectively fixed to second and third fork pipes 122 and 123 each having a through hole at the center, and the first to third fork pipes are fixed into an external box 130 which is built to allow the first, second and third fork pipes to be respectively fixed to the first, second and third rotational shafts through the respective through holes.

10. A refill cartridge for a tape supplier comprising:
a first fork pipe 121, a second fork pipe 122, and a third fork pipe 123 provided with a through hole at the center in an external box 130; and
an ejection outlet 125 provided in the external box 130, ejecting tapes 132a, 132b, . . . inserted between two sheets 127a and 127b,
wherein a tape roll with the tapes inserted between the sheets is fixed to the first fork pipe, the end of one of the sheets is fixed to the second fork pipe, and the end of the other is fixed to an outer surface of the third fork pipe.

11. The refill cartridge for a tape supplier according to claim 10, wherein the tapes are arranged at constant intervals in a straight line.

12. The refill cartridge for a tape supplier according to claim 10 or 11, wherein either the sheet 127a or the sheet 127b includes a sensing portion 160 that senses ejection of the tapes.

13. The refill cartridge for a tape supplier according to claim 10, further comprising fork pipes 126a and 126b for idle roller shafts provided in the vicinity of the ejection outlet 125 to simultaneously pass through the sheets 127a and 127b and the tapes 132a, 132b, . . . .
